(19) United States
(12) Patent Application Publication
(10) Pub. No.: US 2017/0238541 A1
(43) Pub. Date: Aug. 24, 2017

(54) MENTHOL AS A PARABENS ALTERNATIVE

(71) Applicants: Ronald J. Thompson, Cincinnati, OH (US); James M. Thompson, Cincinnati, OH (US)

(72) Inventors: Ronald J. Thompson, Cincinnati, OH (US); James M. Thompson, Cincinnati, OH (US)

(73) Assignee: PARALT, LLC, Cincinnati, OH (US)

(21) Appl. No.: 15/050,732

(22) Filed: Feb. 23, 2016

(51) Int. Cl. A01N 31/06

(52) U.S. Cl. CPC A01N 31/06

(57) ABSTRACT

A method and composition for substituting menthol or a menthol related compound for parabens as a preservative agent in cosmetic and pharmaceutical compositions. The invention provides a means to make cosmetic and pharmaceutical products saber and more marketable by removing all parabens and relying on the antibiotic properties of menthol, or menthol derivatives, to provide antibiotic preservative functions.

### FIELD OF THE INVENTION

The present invention relates in general to providing cosmetics with a preservative to suppress microbial growth on cosmetics, and in particular to menthol and menthol-related compounds a preservative alternative to parabens.

### BACKGROUND OF THE INVENTION

Parabens are the most widely used cosmetic preservatives in personal care products; they stop fungus, bacteria and other microbes from growing in facial creams and makeup. However, parabens can be inadvertently systemically absorbed when applied topically. Once parabens are in the body they can affect the hormonal system by mimicking estrogen, the hormone that promotes cell growth. This promotion of cell growth links parabens with cancer, and in particular, breast cancer. Examples of commonly used parabens, which are esters of para-hydroxybenzoic acid (PHBA), include methyl paraben, ethyl paraben, propyl paraben, butyl paraben and isobutyl paraben, and they can be found listed on thousands of personal care products such as shampoos, mascara and body lotions. Parabens are absorbed through the skin and can then be stored in the body.

In the human body, stratified squamous epithelium forms the outermost layer of the skin and the inner lining of the mouth, esophagus, and vagina. There are two types: keratinized (skin) and non-keratinized, and they have very different properties for absorption of topical drugs and cosmetics. Keratinized surfaces are protected by keratin, which provides a barrier from absorption of topical drugs and cosmetics, including parabens within those drugs and cosmetics. In contrast, non-keratinized surfaces are very absorptive for drugs and cosmetics because they lack the protective keratin layer. Examples of non-keratinized stratified squamous epithelium include the internal portion of the lips, the oral cavity, esophagus, vulva, vagina and anal canal. In fact, the vagina and the rectum are often utilized for systemic drug delivery.

The vaginal mucosa of non-keratinized stratified squamous epithelium is very absorptive for estradiol (molecular weight 272.38 daltons), as well as for parabens molecules that are even smaller than the estradiol molecule. Parabens range in molecular weight from 152 daltons for methyl parabens to 194 daltons for butyl parabens. Topically absorbed drugs and cosmetics are systemically circulated to every cell in the body before being detoxified by the liver. This is referred to as “first pass avoidance” because the drug or cosmetic avoids the liver detoxifying enzymes, especially cytochrome p450. this is true of all topical drugs, injectable drugs, and inhaled drugs; pills and other medications that are generally absorbed via the gastrointestinal tract do not avoid passing through the liver, and are acted upon by liver enzymes before reaching the rest of the organs of the body.

Topically absorbed parabens avoid first pass liver detoxification, and can be systemically potent as endocrine disruptors. Endocrine disruptors are chemicals that, at certain doses, can interfere with the endocrine (or hormone) system in mammals. These disruptions can cause cancerous tumors, birth defects, and other developmental disorders. Recently, questions regarding parabens have been raised among scientists, product safety regulators and cosmetic manufacturers about whether these ubiquitous chemicals, used for almost 70 years, may actually be harmful to our health. For instance, is the rising incidence of breast cancer linked to the fact that parabens, which have a weak ability to mimic estrogen, have been found in breast cancer tumors? Are declining sperm counts and increasing rates of male breast cancer and testicular cancer related to the fact that parabens can be absorbed through our mucous membranes and skin, potentially disrupting our endocrine systems?

There are no definitive answers to these questions yet, but many researchers feel there may be reason for concern, and have been looking for an alternative to parabens as a cosmetic preservative. The European Union (EU) has set up limits on paraben use that have also been reviewed by the European Scientific Committee on Consumer Products (SCCP). In 2006, the SCCP concluded that parabens can be safely used in cosmetic products at concentrations of 0.4% for any individual paraben and 0.8% for total paraben concentrations. The Danish government went further in 2011 by banning the use of parabens in personal care products intended for children younger than 3 years of age. In the United States, the US Food and Drug Administration (FDA) has recommended the same maximum paraben concentrations as suggested by the SCCP and as legislated by the EU. However, it should be noted that the FDA recommendations are only guidelines and manufacturers are not required to follow them. Likewise in Canada, there are no laws regulating paraben concentrations, but Health Canada agrees with the FDA in regards to the safety of parabens and the adoption of maximum concentration guidelines.

In general, parabens are used widely because they are cheap and effective, having replaced formaldehyde as cosmetic preservatives many decades ago as a preservative. But the FDA banned formaldehyde from this use because of its carcinogenic potential. The FDA has studied the safety of parabens for over 30 years, with three positive reviews of parabens safety within the past 10 years. Despite these FDA reassurances, consumers are increasingly purchasing products that are marketed as “Paraben-Free” because of fears that parabens and their estrogenic qualities might be linked to breast cancer, and other cancers. Public pressure has persuaded several governments to introduce regulations on the use of parabens in consumer products. Wal-Mart recently directed all of its suppliers to remove all parabens from the products that they sell.

In 2014, numerous articles were published establishing the risks of parabens exposure and breast cancer activation and development. In the Journal of Applied Toxicity, September 2014, Drs. Khanna, Dash and Darbre reported that exposure to parabens can increase not only proliferation of breast cancer cells in vitro, but also the migratory and invasive activity of human breast cancer cells. This implicates parabens in invasive and metastatic breast cancer. Also in September 2014 Journal of Applied Toxicity, Drs. Wrobel and Gregoraszczuk reported an established a genetic mutation potential of parabens on breast cancer tissue. Therefore, only recently has the risk of paraben exposure and breast cancer activation and development been more clearly defined. The avoidance of paraben exposure can thus potentially reduce the risk of developing breast cancer.

Some examples of replacements for parabens include quaternium-15,imidazolidinyl urea, diazolidinyl urea and dimethyloldimethyl hydantoin, as well as naturally occurring compounds such as grapefruit seed extract, thymol, cinnamaldehyde, citric acid, ascorbic acid, rosemary extract, oregano, thyme, goldenseal root, various flower extracts, and lavender oil, in various combinations. These natural preservatives inhibit microbial growth in vitro, but studies testing antimicrobial activity in cosmetic and food products have provided equivocal results. Therefore, further studies to determine their efficacy, safety and toxicology are warranted before widespread use. Scientists and manufacturers alike are thus still in search of better, alternative preservatives that do not have the estrogenic qualities of parabens.

Accordingly, there is a need to develop a cosmetic preservative that exhibits strong preservative activity, without including preservatives such as parabens that exhibit undesirable side effects.

### SUMMARY OF THE INVENTION

The present invention provides a preservative and composition which allows for the removal of parabens in medicaments already containing menthol, and which also allows for the replacement of parabens with menthol in non-menthol containing medicaments.

A first aspect of the invention relates to a preservative effective in preventing microbial growth on or in a cosmetic or pharmaceutical preparation, the preservative comprising menthol in amounts effective to inhibit microbial growth on or in the preparation, wherein the preparation does not contain parabens.

A second aspect of the invention is a composition for use in a cosmetic or pharmaceutical preparation that does not contain parabens, the composition comprising menthol as an antimicrobial preservative agent, wherein the menthol concentration is sufficient to prevent microbial growth in the cosmetic or pharmaceutical preparation.

The menthol concentration is typically between 0.1% and 10% in the cosmetic or pharmaceutical preparation. In a preferred embodiment the menthol concentration is 0.25%. Typically the menthol concentration is sufficient to pass antimicrobial and preservative effectiveness testing for the cosmetic or pharmaceutical preparation, complies with regulatory bans on parabens used in cosmetic and pharmaceutical preparations, and complies with cosmetic and pharmaceutical retailer's bans on paraben containing products.

While the nature and advantages of the present invention will be more fully appreciated from the following detailed description, showing the contemplated novel combinations and elements as herein described, and more particularly defined by the appended claims, it is understood that changes in the precise embodiments of the present invention are meant to be included within the scope of the claims, except insofar as they may be precluded by the prior art.

### DETAILED DESCRIPTION OF THE INVENTION

The present invention relates to menthol, and menthol-related compounds. As used herein, the terms “menthol” and “menthol-related compounds” are synonymous and shall mean both synthetic menthol and naturally-occurring menthol-containing compounds such as the peppermint oil, corn mint oil, eucalyptus oil, citronella oil, Indian turpentine oil, camphor oil, and cinnamon oil. The invention may further comprise alternate preparations including a base or vehicle. Menthol can be compounded in a non-biologically active base, or in a biologically active base.

Menthol is an organic compound made synthetically or obtained from corn mint, peppermint or other mint oils. It is a waxy, crystalline substance, clear or white in color, which is solid at room temperature and melts slightly above room temperature. Menthol has known local and counterirritant qualities, and it is widely used to relieve minor throat irritation. Menthol also acts as a weak kappa opioid receptor agonist. A topical menthol preparation can be used on the skin as an analgesic, an astringent irritant, or a cooling compound, depending on the menthol concentration. For example a 10% menthol preparation provides analgesic action (e.g. Icy Hot, Mentholatum), a 5% menthol preparation provides astringent action (e.g. Listerine), and all topical menthol preparations having a concentration of greater than 0.01% can be bacteriostatic (stop bacteria from growing) or bactericidal (kill bacteria), but with varying effectiveness.

Regulations for preservative agents that prevent the growth of bacteria are mandated by regulatory agencies worldwide for cosmetic and pharmaceutical products, and are documented by Antimicrobial and Preservative Effectiveness Testing (AET and PET), with strict protocols. The present invention is based on the discovery that menthol, or menthol related compounds, can be an effective antimicrobial and preservative agent in cosmetic and pharmaceutical compositions. This can be accomplished by removal of all parabens in cosmetic and pharmaceutical compositions that contain menthol in an effective concentration to pass Antimicrobial and Preservative Effectiveness Testing protocols. Preservative and antimicrobial effectiveness can also be accomplished by substituting menthol or a menthol related compound for the parabens in cosmetic or pharmaceutical compositions that do not already contain menthol.

The present invention can be used in a preservative effective in preventing microbial growth on or in a cosmetic or pharmaceutical preparation. In a preferred embodiment, the preservative is menthol in amounts effective to inhibit microbial growth on or in the preparation, wherein the preparation does not contain parabens. The invention can also be used in a composition for use in a cosmetic or pharmaceutical preparation that does not contain parabens, the composition comprising menthol as an antimicrobial preservative agent. The menthol concentration is typically between 0.1% and 10% in the inventive cosmetic or pharmaceutical preparation. In a preferred embodiment the menthol concentration is 0.25%. The menthol concentrations disclosed herein are intended to be sufficient to pass antimicrobial and preservative effectiveness testing for the cosmetic or pharmaceutical preparation, to comply with regulatory bans on parabens used in cosmetic and pharmaceutical preparations, and with cosmetic and pharmaceutical retailer's bans on paraben containing products.

U.S. Pat. Nos. 6,322,493 and 6,702,733 to Ronald J. Thompson (co-inventor of the present invention), which are incorporated herein by reference in their entirety, disclose the use of a topical, clitorally-applied cream composition of menthol+1-arginine, which has been marketed under the trade names Sensua and Alura. This composition was FDA approved as a topical medicament in 2002. While the inclusion of menthol in this composition was initially intended as a vehicle to allow the absorption of the L-arginine into tissues and to reflexively increase vaginal lubrication through reflex nocieoceptors, recently the inventors have investigated whether the menthol component of this composition has bactericidal and fungicidal properties that make menthol useful as a parabens alternative preservative, with the ultimate intention of allowing the product to be marketed as “parabens free”.

Data: A 90-day Accelerated Stability Report was done for a composition comprising menthol+1-arginine packaged as a clear to slightly cloudy gel containing no methylparaben, in 1.2 ml packets. The purpose of this hold study was to determine if a composition containing menthol+1-arginine but containing no methylparaben could pass all required testing when held in 1.2 ml foil packets at 40° C. and 75% relative humidity over a 90 day period. 1,500 of the foil packets were placed on accelerated stability (40° C.±2° C. at 75% relative humidity+5%) in a random orientation, for a period of 3 months. 220 packets were pulled at 30, 60 and 90 days for analytical testing. An additional 110 packets were pulled at the 90 day time point and sent out for microbial testing. The remaining packets were kept in the event additional samples were required until all testing was completed, at which point they were destroyed.

Sampling and testing was performed at time zero (0-Days), 30-days, 60-days, and 90-days from the date the stability was initiated (Dec. 12, 2014) for one R&D batch of the product (Batch C41036-RD). The stability of the product in the 1.2 ml foil packets was evaluated in this study. The packets were filled with the bulk product (menthol+1-arginine, with no methylparaben) and were stored to simulate an advanced stability. At the specified time intervals, 220 of the packets were pulled from the stability chamber and emptied into an 8-oz cup in order to create a large enough sample for the required testing, to be evaluated. The testing parameters were for appearance, color, odor, pH, and viscosity to determine viability. Additionally, microbial testing was also performed at time zero (0-Days) and 90-days. Results: This hold study showed that a composition containing menthol+1-arginine, with no methylparaben can be stored in 1.2 ml foil packets for up to 90 days under the conditions of 40° C. and 75% relative humidity without any degradation to the final product that would cause the product to fall out of established specifications. Further, microbial examination of the non-sterile product for specified organisms showed that there was no growth of Staphylococcus aureus, Pseudomonas aeruginosa, or Candida albicans over the 90 day period. These data show that menthol has bactericidal and fungicidal properties that make menthol useful as a parabens alternative preservative.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative system and method, and illustrated examples shown and described. Accordingly, departures may be made from such details without departing from the scope of the invention.

1. A preservative agent for preventing microbial growth in a topical cosmetic preparation, the preservative agent comprising menthol, wherein the topical cosmetic preparation does not contain parabens.

2. The preservative agent of claim 1, wherein the menthol concentration is between 0.1% and 10% in the preparation.

3. The preservative agent of claim 2, wherein the menthol concentration is 0.25%.

4. (canceled)

5. (canceled)

6. (canceled)

7. A composition for use in a topical cosmetic preparation that does not contain parabens, the composition comprising menthol as a preservative agent for preventing microbial growth in the topical cosmetic preparation.

8. The composition of claim 7, wherein the menthol concentration is between 0.1% and 10% in the preparation.

9. The composition of claim 8, wherein the menthol concentration is 0.25%.

10. (canceled)

11. (canceled)

12. (canceled)
